(19) United States
(12) Patent Application Publication
(10) Pub. No.: US 2017/0127497 A1
(43) Pub. Date: May 4, 2017

(54) LIGHTING SYSTEM, LIGHTING CONTROL DEVICE, AND LIGHTING CONTROL METHOD

(71) Applicant: SAMSUNG ELECTRONICS CO., LTD., Suwon-si (KR)

(72) Inventors: Chang Hoon BAEK, Suwon-si (KR); Kil Yoan CHUNG, Suwon-si (KR)

(21) Appl. No.: 15/218,312

(22) Filed: Jul. 25, 2016

(30) Foreign Application Priority Data
Oct. 30, 2015 (KR) 10-2015-0151568

(51) Int. Cl. H05B 37/02; H05B 33/08

(52) U.S. Cl. CPC H05B 37/0254; H05B 37/0218; H05B 37/0227; H05B 33/0842

(57) ABSTRACT

A lighting system includes a sensor unit having at least one sensor, a lighting unit having at least one light emitting diode (LED) and a driver driving the plurality of LEDs, and a control device connected to the driver and the plurality of sensors to communicate therewith. The control device is to store operational information of the driver and information obtained by the plurality of sensors every predetermined period, in which, when a certain event occurs, the control device stores operational information of the driver and information obtained by the plurality of sensors at a time when the event occurs.

### CROSS-REFERENCE TO RELATED APPLICATION

Korean Patent Application No. 10-2015-0151568, filed on Oct. 30, 2015, in the Korean Intellectual Property Office, and entitled: “Lighting System, Lighting Control Device, and Lighting Control Method,” is incorporated by reference herein in its entirety.

### BACKGROUND

1. Field

The present disclosure relates to a lighting system, a lighting control device, and a lighting control method.

2. Description of the Related Art

Semiconductor light emitting devices include a device such as a light emitting diode (LED), and have various advantages such as low power consumption, high brightness, and a relatively long lifespan. Applications of LEDs as light sources are gradually increasing. In particular, the percentage of LEDs used as indoor and outdoor lighting devices in place of conventional fluorescent lights and halogen lamps is increasing.

### SUMMARY

A lighting system may include a sensor unit including at least one sensor, a lighting unit having at least one light emitting diode (LED) and a driver to drive the at least one LED, and a control device connected to the driver and the sensor unit to communicate therewith. The control device may store operational information of the driver and general data output by the sensor unit every predetermined period. When an event occurs, the control device may store operational information of the driver and event data output by the sensor unit at a time when the event occurs.

A lighting control device may include a memory to store data, a communication unit having a plurality of communications interfaces connected to a driver to drive a light emitting diode (LED) and a plurality of sensors, and a processor to store information transmitted through the plurality of communications interfaces to the memory and manage the stored information. The processor may include a configuration circuit to control operations of the driver, and provide a plug-and-play (PnP) function recognizing a device connected to the plurality of communications interfaces.

A lighting control method may include detecting a plurality of sensors and a light emitting diode (LED) driver connected to at least one of a plurality of communications interfaces, collecting information of each of the plurality of sensors to recognize each of the plurality of sensors, and operating the plurality of sensors, storing operational information of the LED driver and data output by the plurality of sensors every predetermined period, and storing operational information of the LED driver and event data output by the plurality of sensors at a time when a certain event occurs, if it is determined that the event has occurred based on the operational information of the LED driver and the information obtained by the plurality of sensors.

A lighting system may include a sensor, a lighting unit including a light emitting diode (LED) and a driver to drive the LED, and a control device connected to the driver and sensor to communicate therewith. The control device may monitor at least one of operational information of the driver and data output from the sensor to determine whether an event has occurred, and to store operational information of the driver and event data when the event has occurred as event information.

### BRIEF DESCRIPTION OF DRAWINGS

Features will become apparent to those of skill in the art by describing in detail exemplary embodiments with reference to the attached drawings in which:

FIG. 1 illustrates a schematic view of a lighting system according to an example embodiment;

FIG. 2 illustrates a block diagram of a lighting system according to an example embodiment;

FIG. 3 illustrates a block diagram of a lighting system according to an example embodiment;

FIG. 4 illustrates a block diagram of a lighting control device according to an example embodiment;

FIG. 5 illustrates a flow chart of lighting control methods according to an example embodiment;

FIG. 6 illustrates a flow chart of lighting control methods according to an example embodiment;

FIGS. 7A and 7B illustrate schematic views of a lighting network system including a lighting system according to example embodiments;

FIGS. 8A and 8B illustrate simple diagrams of white light source modules which may be applied to a lighting system according to example embodiments;

FIG. 9 illustrates a CIE 1931 color space chromaticity diagram;

FIG. 10 illustrates a view of a wavelength conversion material which may be applied to a light source of a lighting system according to an example embodiment;

FIG. 11 illustrates a schematic perspective view of a flat panel lighting device which may be applied to a lighting system according to an example embodiment;

FIGS. 12 and 13 illustrate schematic exploded perspective views of bulb-type lamps which may be applied to a lighting system according to example embodiments; and

FIG. 14 illustrates a schematic exploded perspective view of a bar-type lamp which may be applied to a lighting system according to an example embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

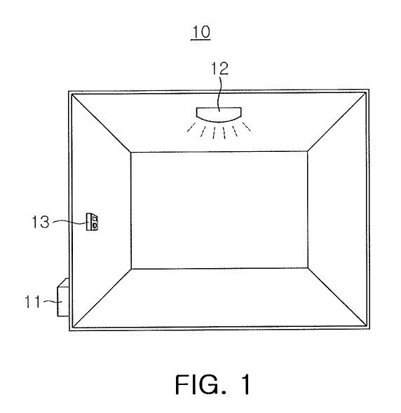

FIG. 1 is a schematic view of a lighting system according to an example embodiment. Referring to FIG. 1, a lighting system 10 according to an example embodiment may include a sensor unit 11 including at least one sensor, a lighting unit 12 having a light emitting diode (LED) employed as a light source and a driver driving the LED, and a control device 13 controlling operations of the sensor unit 11 and the lighting unit 12. The LED may be, e.g., a white light emitting LED, such as those using zinc selenide or gallium nitride on silicon, an organic LED (OLED), quantum dot LEDs, and so forth.

The sensor unit 11 may be installed internally to and externally from a space in which the lighting system 10 is provided. In the example embodiment illustrated in FIG. 1, the sensor unit 11 is assumed to be installed outside the space in which the lighting system 10 is provided. Alternatively, a portion of the at least one sensor may also be installed inside the space in which the lighting system 10 is provided. The portion of the at least one sensor may also collect information on operating states of the LED and of the driver.

The lighting unit 12 may include a plurality of LEDs, a driver driving the plurality of LEDs, and the like. The driver driving the plurality of LEDs may include a direct current-direct current (DC-DC) converter such as a buck converter or a boost converter, a rectifier circuit converting alternating current (AC) to direct current (DC), and the like. A configuration of a circuit included in the driver may be implemented depending on various topologies.

The control device 13 may be connected to the sensor unit 11 and the lighting unit 12 to communicate therewith, and may control operations of the sensor unit 11 and the lighting unit 12. As an example, the control device 13 may include various types of communications interfaces communicating with the sensor unit 11 and the lighting unit 12, a memory storing information output by the sensor unit 11 and the lighting unit 12, a processor controlling operations of the communications interfaces and the memory, and the like. Meanwhile, in the example embodiment illustrated in FIG. 1, the control device 13 is assumed to be disposed separately from the lighting unit 12, and in a different manner, the control device 13 may also be implemented as a single module along with the driver included in the lighting unit 12.

The control device 13 may receive data output by the at least one sensor included in the sensor unit 11 through the various types of communications interfaces. The data may be stored in the memory by the processor, i.e., the processor may collect information obtained by the at least one sensor and store the collected information to the memory every predetermined period, and may construct a database of the collected information and manage the database. This predetermined period may be fixed, may change as scenarios change, e.g., environmental conditions, daytime conditions, nighttime conditions, location, and so forth, and/or may be set by an administrator of the system.

The processor included in the control device 13 may also receive operational information of the driver, e.g., input and output voltages or input and output currents, through the communications interfaces. The processor may store the operational information of the driver along with data output from the at least one sensor as information in the memory, and may manage the stored information. The information stored in the memory by the processor may be transmitted to an external server to thereafter be transmitted to a computer or a mobile device, in response to an administrator's request or every predetermined period, thereby being used to maintain and repair the overall lighting system 10.

For example, when an input voltage and an input current having an identical level are supplied to the lighting system 10, but a level of an output voltage and an output current of the driver drops when the lighting system 10 is initially installed, the administrator may determine that the driver has malfunctioned based on information collected by the control device 13. When brightness of light detected by an illumination sensor decreases even when an output voltage value and an output current value of the driver are within a normal range, the administrator may determine that a portion of the LEDs is defective based on information collected by the control device 13.

Additionally, the lighting system 10 according to the example embodiment may allow the control device 13 to store operational information of the driver and data output by the at least one sensor when a certain event occurs. In this case, the control device 13 may store event data obtained by the at least one sensor and operational information of the driver at a time when the event occurs, regardless of whether the predetermined period in which data is to be stored has passed.

As an example, when a considerable number of LEDs emitting light by the driver are damaged, an output voltage and an output current of the driver may be detected as normal, while brightness of light detected by the illumination sensor included in the sensor unit 11 may rapidly decrease. When a certain value included in operational information of the driver and information obtained by the at least one sensor is significantly changed, the control device 13 may determine that a certain event has occurred, may store operational information of the driver and event data output by the at least one sensor, and may transmit the stored event information to the administrator. The administrator may quickly determine whether the lighting system 10 has a problem or not, based on event information stored in the memory of the control device 13, and may easily find a portion of the lighting system 10 that is defective.

The sensor unit 11 may include various types of sensors to precisely analyze a variety of events. As an example, the sensor unit 11 may include an illumination sensor, a humidity sensor, a temperature sensor, a global positioning system (GPS) sensor, an ambient light sensor, and the like. Among the sensors, the illumination sensor, the humidity sensor, the temperature sensor, and the like, except for the ambient light sensor may be disposed in the lighting unit 12 to be used to check an operating state of the LED employed as the light source. The GPS sensor may provide the control device 13 with information on whether a place, in which the lighting system 10 is installed, is changed. The ambient light sensor may be provided outside the lighting unit 12 to detect ambient light.

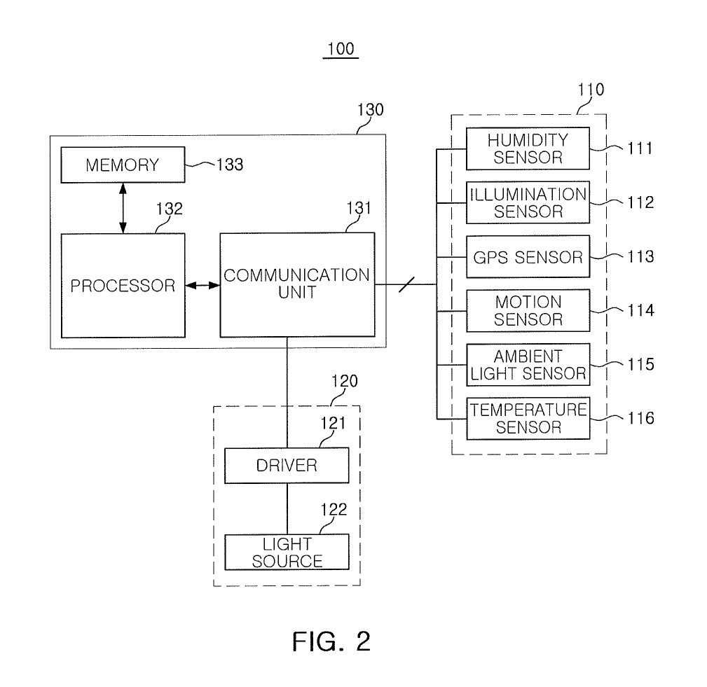

FIG. 2 is a block diagram of a lighting system according to an example embodiment. Referring to FIG. 2, a lighting system 100 according to an example embodiment may include a sensor unit 110 including a plurality of sensors, a lighting unit 120 emitting light, and a control device 130. The control device 130 may be connected to the sensor unit 110 and the lighting unit 120 to communicate therewith through various types of communications interfaces. The lighting unit 120 may include a light source 122 having an LED and a driver 121 supplying a driving voltage, a driving current, and the like to the LED.

The sensor unit 110 may include various types of sensors such as a humidity sensor 111, an illumination sensor 112, a GPS sensor 113, a motion sensor 114, an ambient light sensor 115, and a temperature sensor 116. The number and types of the sensors 111 to 116 included in the sensor unit 110 are not limited to those illustrated in FIG. 2, and may be modified in various ways. A portion of the sensors 111 to 116 included in the sensor unit 110 may also be provided as a single module along with the lighting unit 120. For example, the humidity sensor 111, the illumination sensor 112, the GPS sensor 113, the temperature sensor 116, and the like may be included in a module such as the lighting unit 120.

The sensors 111 to 116 may be connected to the control device 130 to communicate therewith through various types of communications interfaces included in a communication unit 131 of the control device 130. The communication unit 131 may include a variety of communication interfaces such as inter-integrated circuit (I²C), serial peripheral interface (SPI), universal asynchronous receiver/transmitter (UART), digital addressable lighting interface (DALI), RS485, and so forth. The sensors 111 to 116 may be connected to at least one of the communication interfaces to be recognized by the control device 130.

In the example embodiment, the control device 130 may automatically recognize the sensors 111 to 116 connected to the communication unit 131, and may set parameters required for operations of the sensors 111 to 116. For example, when the illumination sensor 112 is connected to the communication unit 131, the control device 130 may automatically receive identification information of the illumination sensor 112 stored in the illumination sensor 112 and information required for operations and control of the illumination sensor 112. The control device 130 may recognize that a device connected to the communication unit 131 corresponds to the illumination sensor 112 using the identification information, and may supply a voltage, a current, and the like required for operations of the illumination sensor 112 to the illumination sensor 112.

The control device 130 may also automatically recognize other peripheral devices connected to the communication unit 131 other than the sensors 111 to 116. A processor 132 may provide a plug-and-play (PnP) function to automatically recognize various types of peripheral devices including the sensors 111 to 116. In addition, when peripheral devices are connected to the communication unit 131, the processor 132 may recognize the peripheral devices, record information, in which settings required for operations of the peripheral devices are input, in a log file format, and store the recorded information in a memory 133.

The processor 132 may store regular data output by the sensors 111 to 116 and operational information of the driver 121 in the memory 133 every predetermined period. In an example embodiment, the processor 132 may store, in the memory 133, data on humidity, temperature, illumination, location, and the like detected by each of the sensors 111 to 116, and an input voltage value, an input current value, an output voltage value, and an output current value of the driver 121. The processor 132 may store at least a portion of information in the memory 133 every predetermined period, and according to the administrator's requests, may retrieve the at least a portion of information from the memory 133 and transmit the retrieved information to the administrator, thereby monitoring the lighting system 100.

Meanwhile, when a certain event occurs, the processor 132 may store, to the memory 133, operational information of the driver 121 and event data output by the sensors 111 to 116 at a time when the event occurs. For example, when it is determined that a certain event has occurred, the processor 132 may store operational information of the driver 121 and event data from the sensors 111 to 116 in the memory 133, regardless of whether the predetermined period has elapsed.

To determine whether the event has occurred or not, the processor 132 may compare both operational information of the driver 121 and data obtained by the sensors 111 to 116 to a predetermined reference range. For example, the processor 132 may compare each of an input voltage value, an input current value, an output voltage value, and an output current value of the driver 121 to the predetermined reference range, and may compare humidity, temperature, and illumination values obtained by the sensors 111 to 116 to the predetermined reference range. As a result of the comparison, when it is determined that a certain value is beyond the predetermined reference range, the processor 132 determines that the event has occurred, and may store operational information of the driver 121 and event data output by the sensors 111 to 116 in the memory 133.

Information recorded in the memory 133 at the time of the event may be marked or flagged to distinguish event information from regular information recorded in the memory 133 at predetermined periods. The event information may be used later to analyze a failure or the like caused by an administrator. When the event occurs, the processor 132 may transmit event information from the memory 133 to an external administrator server automatically or according to the administrator's request. Such transmission may include some type of warning signal.

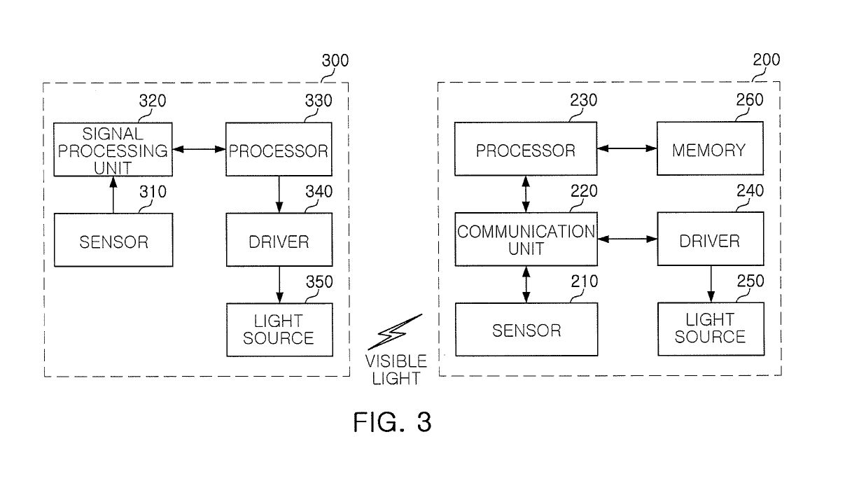

FIG. 3 is a block diagram of a lighting system according to an example embodiment. Referring to FIG. 3, a first lighting system 200 and a second lighting system 300 according to an example embodiment may be connected to each other to communicate therewith. The first lighting system 200 according to the example embodiment may be connected to the second lighting system 300 to communicate therewith. In particular, the first lighting system 200 may communicate with the second lighting system 300 through a visible light receiving sensor included in a sensor unit 210 by visible light communication (VLC), e.g., light fidelity (Li-Fi). A communication method between the first and second lighting systems 200 and 300 is not limited to visible light communications, and may be modified in various ways.

VLC may be used to wirelessly transmit information using light in the visible spectrum that can be recognized by the human eye. Such VLC is wireless, so is different from conventional wired optical communications technology, and uses light in a visible spectrum, i.e., a certain visible light frequency output by a light source described in the example embodiment, so is different from infrared wireless communication. VLC may be used freely without being restricted or permitted in terms of frequency use, unlike radio frequency (RF) wireless communications, may provide excellent physical security, may be visible to a user with the naked eye (although not the information encoded therein), and, principally, may allow the light source to be used for both illumination and communication.

In the example embodiment illustrated in FIG. 3, the first lighting system 200 may include the sensor unit 210 including a visible light receiving sensor, a communication unit 220, a processor 230, a driver 240, a light source 250, and a memory 260. The second lighting system 300 communicating with the first lighting system 200 may also include a sensor unit 310, a signal processing unit 320, a processor 330, a driver 340, and a light source 350.

The signal processing unit 320 may process data to be transmitted and received by VLC. As an example, the signal processing unit 320 may process information collected by the sensor unit 310 into data and transmit the processed data to the processor 330. The processor 330 may control operations of the signal processing unit 320, the driver 340, and the like, and in particular, may control operations of the driver 340 on the basis of data transmitted from the signal processing unit 320. The driver 340 may transmit data to the first lighting system 200 by controlling the light source 350 to emit light in response to a control signal transmitted from the processor 330.

As described above, the sensor unit 210 of the first lighting system 200 may further include a light receiving sensor in addition to the illumination sensor, the humidity sensor, the temperature sensor, the GPS sensor, the ambient light sensor, and the motion sensor exemplified in the example embodiment illustrated in FIG. 2. The light receiving sensor may detect visible light having a predetermined pattern or data encoded therein emitted by the second lighting system 300 and convert the detected visible light at a predetermined wavelength into an electrical signal output to the processor 230 via the communication unit 220. The processor 230 may decode data included in the electrical signal output by the light receiving sensor.

Information decoded by the processor 230 of the first lighting system 200 may include information collected by the sensor unit 310 of the second lighting system 300 and operational information of the driver 340 included in the second lighting system 300. Therefore, the first lighting system 200 may serve as a kind of master device which collects information of the second lighting system 300 to determine whether the second lighting system 300 is defective. When a plurality of the lighting systems are employed, e.g., in an outdoor setting, the first lighting systems 200 that serves as a master device may be disposed at predetermined distances, respectively, to collect operational information of the second lighting systems 300 positioned therearound and information sensed by the sensor unit 310. Therefore, the outdoor lighting may be maintained and repaired more efficiently and conveniently.

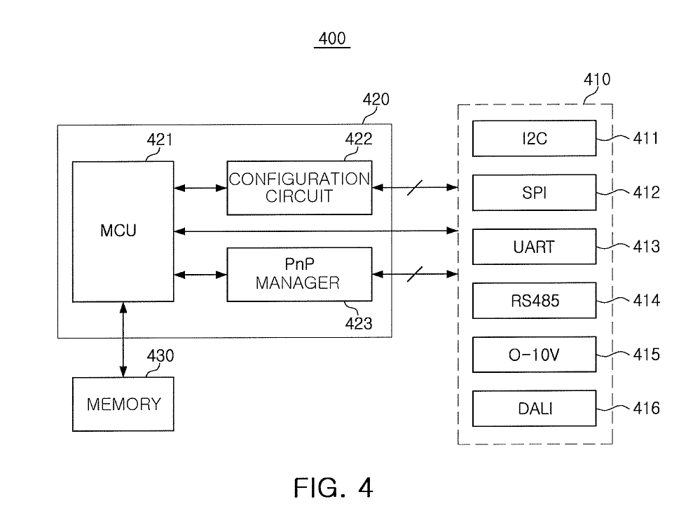

FIG. 4 is a block diagram of a lighting control device that controls a light source according to an example embodiment. Referring to FIG. 4, a lighting control device 400 according to an example embodiment may include a communication unit 410 having a plurality of communications interfaces 411 to 416, a memory 430 storing data, and a processor 420 controlling operations of the communication unit 410 and the memory 430.

The communication unit 410 may include various types of wired and wireless communications interfaces such as an I²C 411, an SPI 412, a UART 413, an RS485 414, a 0-10V 415, and a DALI 416. The communication unit 410 may further include other communications interfaces, such as universal serial bus (USB), Wi-Fi, and Bluetooth, other than those of the example embodiment illustrated in FIG. 4. The communication unit 410 may be connected to various types of sensors provided inside and outside a lighting system, a driver operating a light source in the lighting system, and the like to communicate therewith. For example, the communication unit 410 may relay communications among the sensors, the driver, and the processor 420.

The processor 420 may include a micro controller unit (MCU) 421 performing various operations, a configuration circuit 422, a PnP manager 423, and the like. The MCU 421 may store a variety of information transmitted through the communication unit 410 to the memory 430, may manage the information stored in the memory 430, and may control operations of the configuration circuit 422 and the PnP manager 423.

The configuration circuit 422 may communicate with a driver through a communications interface such as the I²C 411 or the SPI 412, and may store an operating mode of the driver, an output voltage value or an output current value in response to an operating mode of the driver, identification information of an LED employed as a light source, and the like. The configuration circuit 422 may be provided to set a voltage and a current output by the driver, and may be implemented as an integrated circuit (IC) having a read only memory (ROM), or the like.

The PnP manager 423 may provide a PnP function automatically recognizing various types of sensors and peripheral devices connected to the communication unit 410. When a new sensor or peripheral device is connected to the communication unit 410, the PnP manager 423 may collect identification information provided by the new sensor or peripheral device, operational information required for operations of the new sensor or peripheral device, and the like. The MCU 421 may set values required for operations of a sensor or a peripheral device based on information collected by the PnP manager 423, and may output a voltage and a current required for the operations through the communications interfaces 411 to 416. Meanwhile, the configuration circuit 422 and the PnP manager 423 may also be implemented with the MCU 421 and a single IC.

The MCU 421 may record process automatically recognizing a sensor or a peripheral device connected to the communications interfaces 411 to 416 as a log file, and may store the log file in the memory 430. The log file stored in the memory 430 may include operational information of the lighting system obtained when a new sensor or peripheral device is connected to the communication unit 410. Therefore, an administrator or a user of the lighting system may efficiently maintain and repair the lighting system using the log file stored in the memory 430. The log file recorded when the new sensor or peripheral device is mounted to the communication unit 410 may be transmitted to an external server to be sent to a computer or a mobile device of the administrator or the user of the lighting system.

The MCU 421 may collect information obtained by the sensors and operational information of the driver through the various communications interfaces 411 to 416 of the communication unit 410, and may store the data in the memory 430. For example, the MCU 421 may collect information obtained by the sensors and operational information of the driver, and may store the general data every predetermined period. When a certain event occurs, for example, an input voltage, an input current, an output voltage, and an output current of the driver are significantly increased, brightness of the LED measured by the illumination sensor is greatly decreased, and/or the lighting system is abnormally powered off, the MCU 421 may store event data obtained by the sensors and operational information of the driver to the memory 430 regardless of the passage of the predetermined period. The event data stored in the memory 430 may be saved as a database to be managed, and may be used later to analyze a failure of the lighting system and maintain and repair the lighting system.

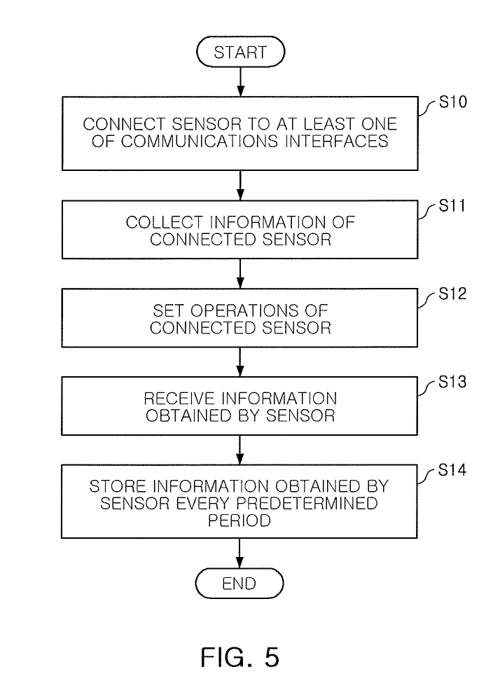

FIG. 5 is a flow chart of a lighting control method according to an example embodiment. Referring to FIG. 5, a lighting control method according to an example embodiment may start from connecting a sensor to at least one of a plurality of communications interfaces included in a control device (S10). The sensor may include various types of sensors, e.g., an illumination sensor, a humidity sensor, a temperature sensor, an ambient light sensor, a GPS sensor, a motion sensor, and the like, as an example.

At least a portion of the sensors may be integrated with a lighting unit of a lighting system. For example, an illumination sensor, a humidity sensor, a temperature sensor, a GPS sensor, and the like may be implemented as a single module integrated with the lighting unit to obtain information on, e.g., brightness of light output by an LED employed as a light source, an ambient humidity and temperature of the LED, a location in which the LED is installed, and the like.

The control device may collect information of the connected sensor through the at least one communications interface to which the sensor is connected (S11). The control device may collect identification (ID) information of the sensor, information on a voltage and a current required for operation of the sensor, and the like, using a PnP manager, and may determine settings required for operations of the sensor based on the collected information (S12).

For example, an illumination sensor, a humidity sensor, a temperature sensor, and the like may have different voltage or current characteristics required for driving thereof. Each of the sensors may store information on voltage and current characteristics required for driving thereof in addition to ID information to an electric circuit including a resistor IC, a switch device, a diode, and the like. The control device may allow each sensor to automatically operate without a user's additional settings by collecting information stored in the electric circuit and supplying a voltage and a current required for operations of each sensor to each sensor.

When setup required for operations of each sensor is completed, the control device may receive information obtained by each sensor (S13), and may store the received information to a memory every predetermined period (S14). The predetermined period in which information is stored to the memory may follow a certain value set as a default, or may be properly determined by a user or an administrator. The information stored in the memory may be used later for the administrator to maintain and repair the lighting system. In another example embodiment, the control device may store operational information of a driver operating the light source—an input voltage, an input current, an output voltage, and an output current of the driver—in the memory, in addition to information obtained by each sensor.

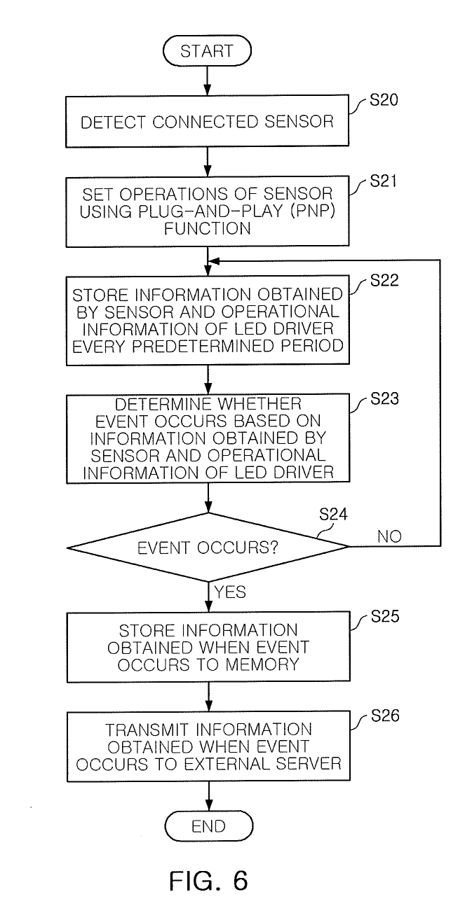

FIG. 6 is a flow chart of a lighting control method according to an example embodiment. Referring to FIG. 6, a method of operating a lighting system according to an example embodiment may start from allowing a control device of the lighting system to detect sensors connected through a communications interface (S20). The control device may collect ID information of the sensors, information on a voltage and a current required for operations of the sensors, and the like from the sensors connected through the communications interface.

The control device may determine settings required for operations of the sensors using a PnP function (S21). Operation (S21) may be similar to operations (S11 and S12) of the example embodiment described above with reference to FIG. 5. Each of the sensors may have different settings such as a voltage and a current required for operations thereof, and may have different formats of data transmitted and received with the control device depending on communications interfaces to which each sensor is connected. The control device may determine settings required for operations of each sensor using the PnP function.

The control device may then obtain information obtained by each sensor and operational information of a driver driving an LED, and may store the obtained information to a memory every predetermined period (S22). The information obtained by each sensor may include brightness of light output by the LED, internal humidity and temperature of the lighting unit including the LED, a location in which the lighting system is installed, brightness of ambient light flowing in a space in which the lighting system is installed, and the like, and may be determined depending on types of a plurality of the sensors connected to the control device and the number of the sensors. As described above, the humidity sensor, the temperature sensor, the illumination sensor, and the like may be installed in the lighting unit including the LED to provide the control device with information on an ambient humidity and temperature of the LED, brightness of light output by the LED, and the like.

The control device of the lighting system may determine whether an event occurs based on the information obtained by each sensor and the operational information of the driver (S23). The event defined in operation S23 may include cases such as relocation and installation of the lighting system, a failure or a malfunction of at least a portion of components included in the lighting system, an abnormal movement detected by the motion sensor included in the lighting system, or any other significant deviation from a reference parameter.

For example, when output of the driver is increased or decreased enough to be beyond a normal range due to damage to a portion of components of the driver, the control device may determine that an event has occurred. Even in a case in which there is no change in input and output of the driver, when brightness of the LED detected by the illumination sensor is decreased due to damage of a portion of the LED caused by an external shock or the like, the control device may determine that an event has occurred. When internal humidity and temperature of the lighting unit is increased due to humidity or heat applied from the outside, the control device may also determine that an event has occurred. When the lighting system is provided in a room and the motion sensor is included in the lighting system, when an abnormal movement is detected by the motion sensor, the control device may determine an event has occurred.

To determine whether an event occurs, the control device may have a predetermined reference range. The reference range may be stored to a memory or a processor of the control device, and different reference ranges may be applied to respective parameters included in information obtained by each sensor and operational information of the driver. For example, reference ranges for an input voltage and an output voltage of the driver may be different from each other.

When a comparison between a reference range and the information obtained by each sensor and the operational information of the driver, indicates that an event has not occurred (S24), and the control device may store, to the memory, information obtained by each sensor and operational information of the driver every predetermined period without an additional operation. When the comparison between the reference range and the information obtained by each sensor and the operational information of the driver, indicates that an event has occurred (S24), the control device may store, in the memory, information obtained at a time when the event occurred (S25).

The information stored in the memory in operation S25 may be event data output by each sensor and operational information of the driver just before and after the event has occurred. The control device may store, in the memory, event information obtained by each sensor and the operational information of the driver when the event has occurred, regardless of whether the predetermined period applied in operation S22 has elapsed. The event information may be used later for an administrator or a user to analyze a cause of failure of the lighting system, a result thereof, and the like. Therefore, the lighting system according to the example embodiment may provide a black box function of monitoring an operating state of the lighting system and providing event data for analysis of a cause of failure to the administrator or the user.

Further, when the event has occurred, the control device may transmit event information to an external server (S26). The external server may be accessed by the administrator or the user of the lighting system. For example, in an Internet of Things (IoT) environment, when an event occurs in the lighting system, the control device may transmit the fact that the event has occurred to mobile devices, e.g., a smartphone and a tablet PC, to quickly notify the user of the lighting system of the fact. In addition, the control device may transmit event data to the administrator of the lighting system so that the administrator may quickly maintain and repair the lighting system.

The lighting system according to the example embodiment may collect data output by each sensor and operational information of the driver in real time to determine whether an event has occurred, and when the event has not occurred, may store information collected every predetermined period in the memory. When the event has occurred, the lighting system may store event information in the memory, and may notify the user and the administrator of the lighting system of the event occurrence. Therefore, when the lighting system malfunctions or an intruder enters a space in which the lighting system is installed, the lighting system may inform the user and the administrator of the lighting system of this, thereby implementing a more stable operating environment.

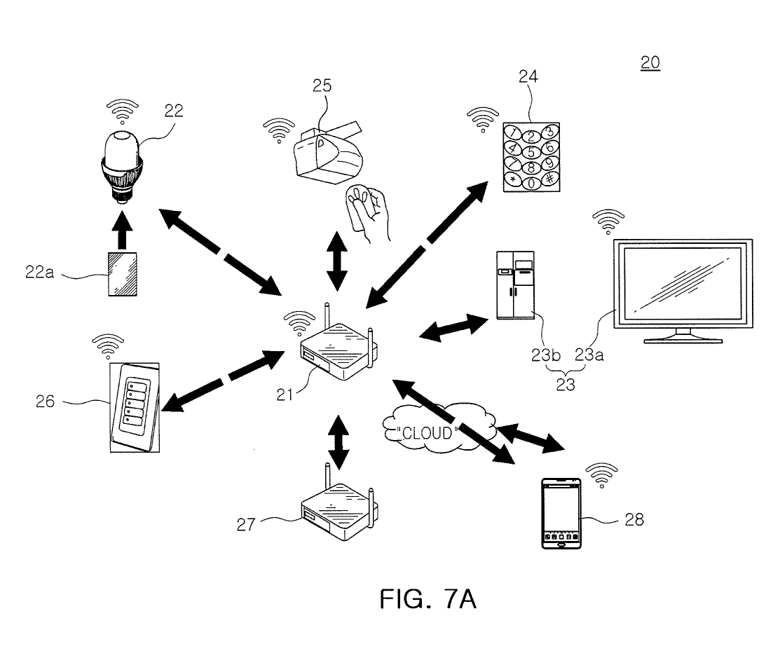

FIGS. 7A and 7B are schematic views of a lighting network system including a lighting system according to example embodiments.

First, FIG. 7A is a schematic view of a lighting network system employable indoors. A lighting network system 20 according to an example embodiment may be a complex smart lighting-network system in which lighting technology, Internet of Things (IoT) technology, wireless communications technology, and the like using a light emitting device, such as an LED, converge. The network system 20 may be implemented using various types of lighting devices and wired and wireless communications devices, and may be realized by a sensor, a controller, a communication unit, software for network control and maintenance, and the like.

The network system 20 may be applied to an open space such as a park or a street, as well as to a closed space defined within a building such as a home or an office. The network system 20 may be implemented on the basis of an IoT environment to collect and process various pieces of information and provide the collected and processed information to a user. An LED lamp 22 included in the network system 20 may serve to check and control operating states of other devices 23 to 28 included in the IoT environment via VLC, as well as to receive information regarding surroundings from a gateway or router 21 to control lighting of the LED lamp 22 itself.

The LED lamp 22 may be the lighting systems 10, 100, 200, and 300, and may include a plurality of sensors. The plurality of sensors may collect information on humidity, temperature, and illumination for monitoring an internal state of the LED lamp 22, as well as collect information regarding a surrounding environment of the LED lamp 22. A control device mounted in the LED lamp 22 may collect operational information of the LED lamp 22 along with information on internal humidity, temperature, and illumination of the LED lamp 22, may periodically store the collected operational information, and when an abnormal operation or the like of the LED lamp 22 is detected, may quickly report abnormalities of the LED lamp 22 to a mobile device 28 of a user through the gateway 21.

Referring to FIG. 7A, the network system 20 may include the gateway 21 processing data transmitted and received according to different communications protocols, the LED lamp 22 connected to the gateway or router 21 to communicate therewith and including an LED, a plurality of sensors, and the like, and the plurality of devices 23 to 28 connected to the gateway 21 to communicate therewith according to various wireless communications schemes. To implement the network system 20 on the basis of the IoT environment, the respective devices 23 to 28 including the LED lamp 22 may include at least one communications module. As an example, the LED lamp 22 may be connected to the gateway 21 to communicate therewith by wireless communications protocols such as Wi-Fi, Zigbee®, Li-Fi, and Bluetooth, and for this, may have at least one communication module 22a for the lamp 22.

As described above, the network system 20 may be applied to an open space such as a park or a street, as well as to a closed space such as a home or an office. When the network system 20 is applied to a home, the plurality of devices 23 to 28 included in the network system 20 and connected to the gateway 21 to communicate therewith on the basis of IoT technology may include home appliances 23, a digital door lock 24, a garage door lock 25, a lighting switch 26 installed on a wall or the like, a router 27 for wireless network relay, and a mobile device 28, e.g., a smartphone, a tablet PC, or a laptop PC.

In the network system 20, the LED lamp 22 may check the operating states of the various devices 23 to 28 or may automatically control luminance of the LED lamp 22 itself according to the devices' surroundings and circumstances using wireless communications networks (Zigbee®, Wi-Fi, Li-Fi, and the like) installed in a home. Using Li-Fi communications using visible light emitted by the LED lamp 22 may allow the devices 23 to 28 included in the network system 20 to be controlled.

First, the LED lamp 22 may automatically control the luminance of the LED lamp 22 on the basis of information regarding surroundings transmitted from the gateway 21 through the communications module for the lamp 22a, or information regarding surroundings collected by a sensor mounted in the LED lamp 22. For example, brightness of the LED lamp 22 may be automatically controlled according to a type of a program being broadcast on a television 23a or brightness of an image. To this end, the LED lamp 22 may receive operational information of the television 23a from the communications module for the lamp 22a connected to the gateway 21. The communications module for the lamp 22a may be integrally modularized with a sensor and/or a controller included in the LED lamp 22.

For example, when a program broadcast on the television 23a is a drama, a color temperature of illumination may be controlled to be less than or equal to 12,000K, for example, 5,000K, according to predetermined settings to control colors, thereby creating a cozy atmosphere. In a different manner, when a program is a comedy, the network system 20 may be configured in such a manner that a color temperature of illumination may be increased to 5,000K or more and to be blue-based white lighting according to predetermined settings.

When a certain period of time passes after the digital door lock 24 is locked while there is no person in a home, the network system 5000 may allow all LED lamps 22 turned on to be turned off, thereby preventing a waste of electricity. Alternatively, when a security mode is set by the mobile device 28 or the like, if the digital door lock 24 is locked while there is no person in a home, the network system 5000 may allow the LED lamps 22 to be kept turned on.

Operations of the LED lamp 22 may also be controlled according to information regarding surroundings collected by various types of sensors connected to the network system 20. For example, when the network system 20 is implemented in a building, a light, a position sensor, and a communications module may be combined with each other in the building to collect information on locations of people in the building so that the light may be turned on or off, or the collected information may be provided to a user in real time, thereby enabling facility management or efficient use of an idle space. In general, since a lighting device such as the LED lamp 22 is disposed in almost all of the spaces on each floor of a building, various pieces of information in the building may be collected by a sensor integrated with the LED lamp 22, and the collected information may be used to manage facilities or utilize an idle space.

Meanwhile, a combination of the LED lamp 22 with an image sensor, a storage device, the communications module for the lamp 22a, and the like may allow the LED lamp 22 to be utilized as a device that may maintain building security or detect and deal with an emergency. For example, when a smoke or temperature sensor is attached to the LED lamp 22, the LED lamp 22 may quickly detect whether a fire or the like occurs, thereby significantly reducing damage to the building, and may also control brightness of lighting considering external weather or an amount of sunshine, thereby saving energy and providing a comfortable lighting environment.

As described above, the network system 20 may be applied to an open space such as a park or a street, as well as to a closed space such as a home or an office. When the network system 20 is desired to be applied to an open space without physical restrictions, the implementation of the network system 20 may be relatively difficult depending on restrictions on wireless communication coverage, communication interference caused by various obstacles, and the like. Each lighting fixture may be provided with a sensor, a communications module, and the like, and may be used as an information collecting unit and a communication relay unit, thereby realizing the network system 20 more efficiently in an open environment described above. This will hereinafter be described with reference to FIG. 7B.

FIG. 7B illustrates an example embodiment of a lighting network system 30 applied to an open space. Referring to FIG. 7B, the lighting network system 30 according to the example embodiment may include a communications connection device 31, a plurality of lighting fixtures 32 and 33 installed at predetermined intervals and connected to the communications connection device 31 to communicate therewith, a server 34, a computer 35 managing the server 34, a communications base station 36, a communications network 37 connecting the above-mentioned communicable devices, a mobile device 38, and the like.

Each of the plurality of lighting fixtures 32 and 33 installed in an external open space such as a street or a park may include smart engines 32a and 33a, respectively. The smart engines 32a and 33a may include a sensor collecting information regarding surroundings, a communications module, and the like, in addition to a light emitting device emitting light and a driver driving the light emitting device. The communications module may allow the smart engines 32a and 33a to communicate with other surrounding devices according to communications protocols such as Wi-Fi, Zigbee®, and Li-Fi.

For example, the smart engines 32a and 33a may correspond to a lighting system according to an example embodiment. The respective smart engines 32a and 33a may collect information on an internal illumination, humidity, temperature, and the like of the lighting fixtures 32 and 33 and operational information of the lighting fixtures 32 and 33—an input voltage, an output voltage, an input current, or an output current—In addition to information regarding surroundings. The smart engines 32a and 33a may determine whether the lighting fixtures 32 and 33 normally operate based on the collected information, and when it is determined that a certain event has occurred, may transmit the fact that the event has occurred to the server through the communications network 37.

Meanwhile, one smart engine 32a may be connected to the other smart engine 33a to communicate therewith. At this time, Wi-Fi extension technology (Wi-Fi mesh) or visible light communication technology (Li-Fi) may be applied to communications between the smart engines 32a and 33a. At least one smart engine 32a may be connected to the communications connection device 31 linked to the communications network 37 through wired and wireless communications. To increase communications efficiency, several smart engines 32a and 33a may be grouped into one to be connected to a single communications connection device 31. Visible communications between the smart engines 32a and 33a may be similar to those illustrated in the example embodiment of FIG. 3.

The communications connection device 31 may relay communications between the communications network 37 and other devices, as an access point (AP) that enables wired and wireless communications. The communications connection device 31 may be connected to the communications network 37 by at least one of wired and wireless methods, and as an example, may be mechanically accommodated in one of the lighting fixtures 32a and 33a.

The communications connection device 31 may be connected to the mobile device 38 using a communications protocol such as Wi-Fi. A user of the mobile device 38 may receive information regarding surroundings collected by the plurality of smart engines 32a and 33a through the communications connection device 31 connected to the smart engine 32a of an adjacent surrounding lighting fixture 32. The information regarding the surroundings may include surrounding traffic information, weather information, and the like. The mobile device 38 may also be connected to the communications network 37 by a wireless cellular communications method such as 3G or 4G through the communications base station 36.

Meanwhile, the server 34 connected to the communications network 37 may monitor operating states or the like of the respective lighting fixtures 32 and 33 while receiving information collected by the smart engines 32a and 33a respectively mounted in the lighting fixtures 32 and 33. To manage the respective lighting fixtures 32 and 33 on the basis of the monitoring results of the operating states of the respective lighting fixtures 32 and 33, the server 34 may be connected to the computer 35 providing a management system. The computer 35 may execute software or the like able to monitor and manage operating states of the respective lighting fixtures 32 and 33, particularly the smart engines 32a and 33a.

Various communication methods may be applied to send information collected by the smart engines 32a and 33a to the mobile device 38 of the user. Referring to FIG. 7B, the communications connection device 31 connected to the smart engines 32a and 33a may allow information collected by the smart engines 32a and 33a to be transmitted to the mobile device 38, or the smart engines 32a and 33a and the mobile device 38 to be connected to each other to directly communicate with each other. The smart engines 32a and 33a and the mobile device 38 may directly communicate with each other through VLC, e.g., Li-Fi.

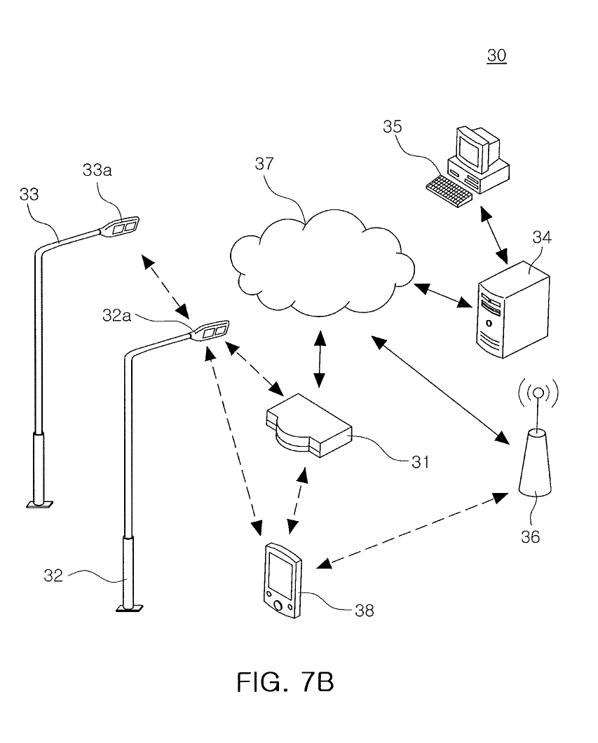

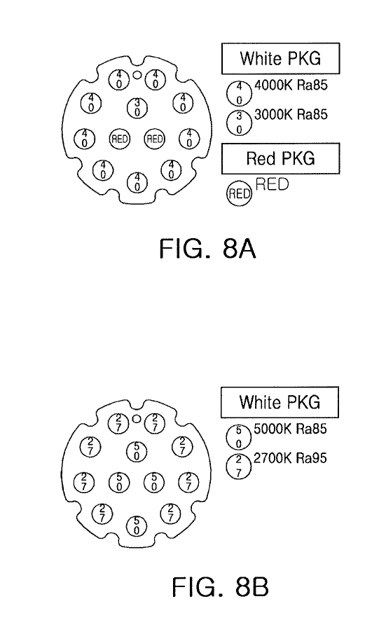

FIGS. 8A and 8B are simple diagrams of white light source modules which may be applied to a lighting system according to example embodiments. FIG. 9 is a CIE 1931 color space chromaticity diagram.

The white light source modules respectively illustrated in FIGS. 8A and 8B may include a plurality of light emitting device packages mounted on circuit boards, respectively. A plurality of light emitting device packages mounted in a single white light source module may be configured of a same kind of package generating light having an identical wavelength, but as in the example embodiment, may also be formed of different kinds of packages generating light having different wavelengths.

Referring to FIG. 8A, the white light source module may be configured by combining white light emitting device packages 30 and 40 having color temperatures 3,000K and 4,000K, respectively, with red light emitting device packages RED. The white light source module may provide white light having a color temperature from 3,000K to 4,000K and a color rendering index from 85 Ra to 100 Ra.

In another example embodiment, a white light source module may be configured of only white light emitting device packages, and a portion thereof may emit white light having different color temperatures. For example, as illustrated in FIG. 8B, a combination of a white light emitting device package 27 having a color temperature of 2,700K and a white light emitting device package 50 having a color temperature of 5,000K may allow white light having a color temperature from 2,700K to 5,000K and a color rendering index (CRI) from 85 Ra to 99 Ra to be provided. Here, the number of light emitting device packages having respective color temperatures may vary according to default color temperature setting values. For example, if a lighting device has a default color temperature setting value adjacent to 4,000K, the lighting device may include more light emitting device packages having a color temperature of 4,000K than those having a color temperature of 3,000K or red light emitting device packages.

As such, different kinds of light emitting device packages may include at least one of a light emitting device in which a blue light emitting device is combined with a yellow, green, red or orange phosphor to emit white light, or purple, blue, green, red or an infrared light emitting device, thereby adjusting a color temperature and a CRI of white light. The above-mentioned white light source modules may be employed as light sources for various types of lighting devices.

A single light emitting device package may determine a required color of light according to wavelengths of a light emitting diode (LED) chip, for example, a light emitting device, and to types and mixing ratios of phosphors, and when a determined color of light is white, may adjust a color temperature and a CRI thereof.

For example, when an LED chip emits blue light, a light emitting device package including at least one of yellow, green, and red phosphors may emit white light having a variety of color temperatures according to mixing ratios of the yellow, green, and red phosphors. In a different manner, a light emitting device package in which a green or red phosphor is applied to a blue LED chip may emit green or red light. As such, a combination of a light emitting device package emitting white light and a light emitting device package emitting green or red light may allow a color temperature and a color rendering index of white light to be adjusted. In addition, the light emitting device package may include at least one of light emitting devices emitting purple, blue, green, red or infrared light.

In this case, a lighting device may adjust a CRI of a sodium (Na) lamp or the like to the level of sunlight, and may also emit white light having various color temperatures from 1,500K to 20,000K. If necessary, the lighting device may emit purple, blue, green, red, and orange visible light or infrared light to adjust lighting color according to devices' surroundings or to set a desired mood. The lighting device may also emit light having a certain wavelength that promotes plant growth.

White light generated by combining a blue light emitting device with yellow, green, and red phosphors and/or green and red light emitting devices may have at least two peak wavelengths, and as illustrated in FIG. 9, (x, y) coordinates of the CIE 1931 color space chromaticity diagram may be located in an area of segments connecting coordinates: (0.4476, 0.4074), (0.3484, 0.3516), (0.3101, 0.3162), (0.3128, 0.3292), and (0.3333, 0.3333). Alternatively, (x, y) coordinates may be located in an area surrounded by the segments and a blackbody radiation spectrum. A color temperature of the white light may range from 1,500K to 20,000K. In FIG. 9, white light adjacent to Point E (0.3333, 0.3333) below the blackbody radiation spectrum may be used as a light source for lighting to create clearer viewing conditions to the naked eye while light having a yellow-based component is reduced. Thus, a lighting product using white light in the vicinity of the Point E (0.3333, 0.3333) below the blackbody radiation spectrum may be useful as lighting for a retail space in which consumer goods are sold.

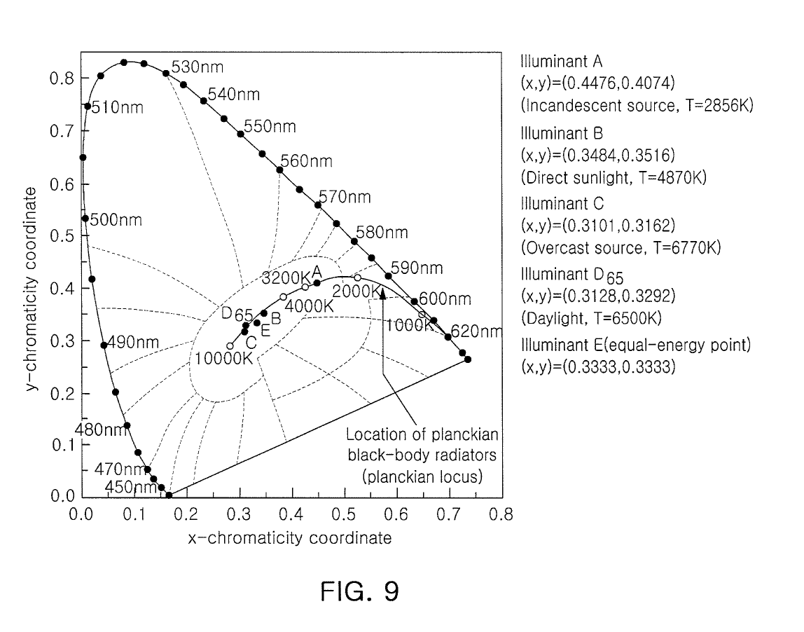

FIG. 10 is a view of a wavelength conversion material which may be applied to a light source of a lighting system according to an example embodiment.

Various types of materials such as a phosphor and a quantum dot may be used as a material converting a wavelength of light emitted by a light emitting device.

In an example embodiment, a phosphor applied to a wavelength conversion material may have the following formulae and colors: yellow and green Y₃Al₅O₁₂:Ce, yellow and green Tb₃Al₅O₁₂:Ce, and yellow and green Lu₃Al₅O₁₂:Ce (oxide-based); yellow and green (Ba,Sr)₂SiO₄:Eu and yellow and orange (Ba,Sr)₃SiO₅:Ce (silicate-based); green β-SiAlON:Eu, yellow La₃Si₆N₁₁:Ce, orange α-SiAlON:Eu, red CaAlSiN₃:Eu, red Sr₂Si₅N₈:Eu, red SrSiAl₄N₇:Eu, and red SrLiAl₃N₄:Eu (nitride-based), Ln₄₋ₓ(Eu_{z}M_{1-z})ₓSi_{12-y}Al_{y}O_{3+x+y}N_{18-x-y} (0.5≦x≦3, 0<z<0.3, 0≦y≦4)—Formula (1), in which Ln may be at least one type of element selected from the group consisting of group IIIa elements and rare earth elements, and M may be at least one type of element selected from the group consisting of calcium (Ca), barium (Ba), strontium (Sr), and magnesium (Mg); and KSF-based red K₂SiF₆:Mn₄⁺, KSF-based red K₂TiF₆:Mn₄⁺, KSF-based red NaYF₄:Mn₄⁺, and KSF-based red NaGdF₄:Mn₄⁺ (fluoride-based) (for example, a composition ratio of manganese (Mn) may satisfy 0<z<=0.17).

A phosphor composition may be required to conform with stoichiometry, and respective elements thereof may be replaced with other elements in each group in which a corresponding element is included on the periodic table. For example, Sr may be substituted with Ba, Ca, Mg, and the like of alkaline earth metals (group II), and yttrium (Y) may be replaced with terbium (Tb), lutetium (Lu), scandium (Sc), gadolinium (Gd), and the like of lanthanides. Europium (Eu) or the like, an activator, may be substituted with cerium (Ce), terbium (Tb), praseodymium (Pr), erbium (Er), ytterbium (Yb), and the like according to required energy levels. An activator may only be applied to the phosphor composition, or an additional sub-activator or the like may be applied to the phosphor composition to modify characteristics thereof.

In particular, the fluoride-based red phosphors may be coated with a fluoride not containing Mn, respectively, or may further include an organic coating on a surface coated with a fluoride not containing Mn, in order to improve reliability at high temperatures and high humidity. In the case of the fluoride-based red phosphor described above, since a narrow full width at half maximum (FWHM) less than or equal to 40 nm may be implemented unlike other phosphors, the fluoride-based red phosphor may be used for a high-resolution television, such as an ultra-high definition (UHD) TV.

Table 1 below indicates types of phosphors which may be applied to respective application fields in a light emitting device package in which a blue LED chip having a dominant wavelength from 440 nm to 460 nm or an ultraviolet LED chip having a dominant wavelength from 380 nm to 440 nm is used.

TABLE 1

| Use | Phosphor |
|---|---|
| LED TV | β-SiAlON:Eu²⁺, (Ca, Sr)AlSiN₃:Eu²⁺, La₃Si₆N₁₁:Ce³⁺, |
| BLU | K₂SiF₆:Mn⁴⁺, SrLiAl₃N₄:Eu, |
| | Ln₄₋ₓ(Eu_{z}M_{1-z})ₓSi_{12-y}Al_{y}O_{3+x+y}N_{18-x-y}(0.5 ≦ x ≦ 3, 0 < z < |
| | 0.3, 0 < y ≦ 4), K₂TiF₆:Mn⁴⁺, NaYF₄:Mn⁴⁺, NaGdF₄:Mn⁴⁺, |
| | K₃SiF₇:Mn⁴⁺ |
| Lighting | Lu₃Al₅O₁₂:Ce³⁺, Ca-α-SiAlON:Eu²⁺, La₃Si₆N₁₁:Ce³⁺, |
| | (Ca, Sr)AlSiN₃:Eu²⁺, Y₃Al₅O₁₂:Ce³⁺, K₂SiF₆:Mn⁴⁺, |
| | SrLiAl₃N₄:Eu, Ln₄₋ₓ(Eu_{z}M_{1-z})ₓSi_{12-y}Al_{y}O_{3+x+y}N_{18-x-y}(0.5 ≦ |
| | x ≦ 3, 0 < z < 0.3, 0 < y ≦ 4), K₂TiF₆:Mn⁴⁺, NaYF₄:Mn⁴⁺, |
| | NaGdF₄:Mn⁴⁺, K₃SiF₇:Mn⁴⁺ |
| Side | Lu₃Al₅O₁₂:Ce³⁺, Ca-α-SiAlON:Eu²⁺, La₃Si₆N₁₁:Ce³⁺, |
| View | (Ca, Sr)AlSiN₃:Eu²⁺, Y₃Al₅O₁₂:Ce³⁺, |
| (Mobile, | (Sr, Ba, Ca, Mg)₂SiO₄:Eu²⁺, K₂SiF₆:Mn⁴⁺, SrLiAl₃N₄:Eu, |
| Laptop | Ln₄₋ₓ(Eu_{z}M_{1-z})ₓSi_{12-y}Al_{y}O_{3+x+y}N_{18-x-y}(0.5 ≦ x ≦ 3, 0 < z < |
| PC) | 0.3, 0 < y ≦ 4), K₂TiF₆:Mn⁴⁺, NaYF₄:Mn⁴⁺, NaGdF₄:Mn⁴⁺, |
| | K₃SiF₇:Mn⁴⁺ |
| Electronic | Lu₃Al₅O₁₂:Ce³⁺, Ca-α-SiAlON:Eu²⁺, La₃Si₆N₁₁:Ce³⁺, |
| device | (Ca, Sr)AlSiN₃:Eu²⁺, Y₃Al₅O₁₂:Ce³⁺, K₂SiF₆:Mn⁴⁺, |
| (Head | SrLiAl₃N₄:Eu, Ln₄₋ₓ(Eu_{z}M_{1-z})ₓSi_{12-y}Al_{y}O_{3+x+y}N_{18-x-y}(0.5 ≦ |
| Lamp, | x ≦ 3, 0 < z < 0.3, 0 < y ≦ 4), K₂TiF₆:Mn⁴⁺, NaYF₄:Mn⁴⁺, |
| etc.) | NaGdF₄:Mn⁴⁺, K₃SiF₇:Mn⁴⁺ |

In addition, a wavelength conversion material may contain a quantum dot (QD) used to replace a phosphor or to be mixed with a phosphor.

FIG. 10 is a cross-sectional view of a QD. The QD may have a core-shell structure using a group III-V compound semiconductor or a group II-VI compound semiconductor. For example, the QD may have a core, e.g., cadmium selenide (CdSe) or indium phosphide (InP), and a shell, e.g., zinc sulfide (ZnS) or zinc selenide (ZnSe). The QD may also include a ligand stabilizing the core and the shell. For example, a diameter of the core may range from 1 nm to 30 nm, and in an example embodiment, may range from 3 nm to 10 nm. A thickness of the shell may range from 0.1 nm to 20 nm, and in an example embodiment, may range from 0.5 nm to 2 nm.

The QD may implement various colors according to sizes thereof, and for instance, when used as a phosphor substitute, may be employed as a red or green phosphor. When the QD is used, a narrow FWHM (for example, about 35 nm) may be implemented.

A wavelength conversion material may be provided to be contained in an encapsulant, or may be previously manufactured in a film form so that the wavelength conversion material may be attached to a surface of an optical device such as an LED chip or a light guide plate. When the wavelength conversion material previously manufactured in the film form is used, a wavelength conversion material having a uniform thickness may be easily implemented.

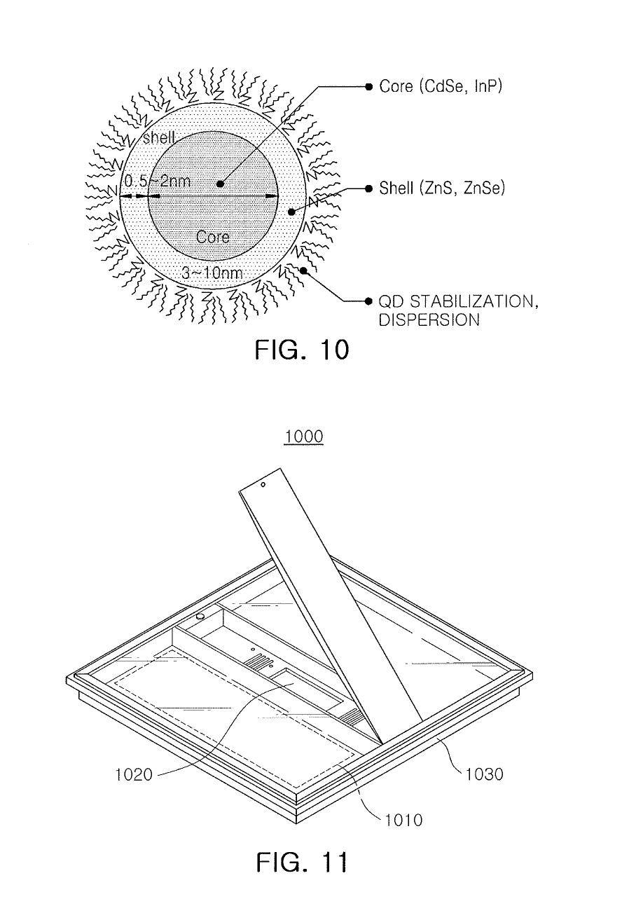

FIG. 11 is a schematic perspective view of a flat panel lighting device which may be applied to a lighting system according to an example embodiment. Referring to FIG. 11, a flat panel lighting device 1000 may include a light source module 1010, a power supply 1020, and a housing 1030. According to an example embodiment, the light source module 1010 may include a light emitting device array as a light source, and the power supply 1020 may include a light emitting device driver.

The light source module 1010 may include the light emitting device array, and may have an overall flat shape. According to an example embodiment, the light emitting device array may include a light emitting device and a controller storing driving information of the light emitting device. The light source module 1010 may also have a plurality of sensors disposed therein to detect surroundings of an LED employed as a light source. The controller may store information obtained by the plurality of sensors and the driving information of the light emitting device every predetermined period, and may monitor the stored information to check whether an event occurs.

The power supply 1020 may be configured to supply power to the light source module 1010. The housing 1030 may have a space to receive the light source module 1010 and the power supply 1020 therein, and may have a hexahedral shape with an open side surface thereof, but is not limited thereto. The light source module 1010 may be disposed to emit light to the open side surface of the housing 1030.

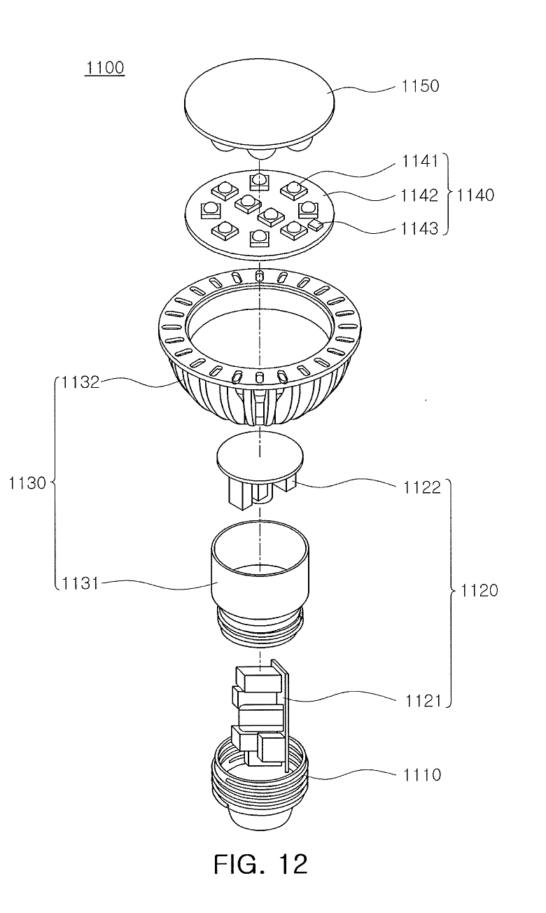

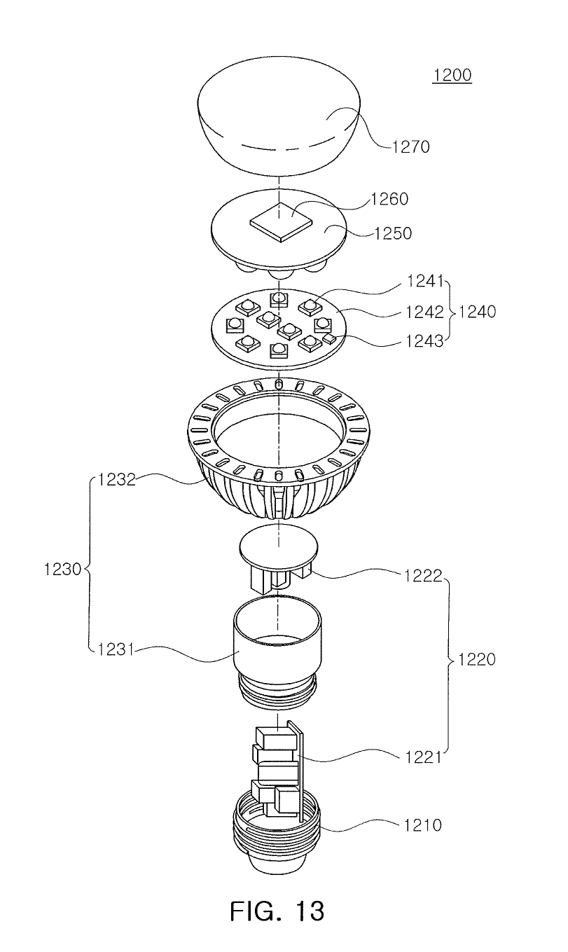

FIGS. 12 and 13 are schematic exploded perspective views of bulb-type lamps which may be applied to a lighting system according to example embodiments.

First, referring to FIG. 12, a lighting device 1100 may include a socket 1110, a power supply 1120, a heat sink 1130, a light source module 1140, and an optical unit 1150. According to an example embodiment, the light source module 1140 may include a light emitting device array, and the power supply 1120 may include a light emitting device driver.

The socket 1110 may be configured to replace that of a conventional lighting device. Power supplied to the lighting device 1100 may be applied through the socket 1110. As illustrated in FIG. 12, the power supply 1120 may be separately attached with a first power supply 1121 and a second power supply 1122. The heat sink 1130 may include an internal heat sink 1231 and an external heat sink 1232. The internal heat sink 1131 may be directly connected to the light source module 1140 and/or the power supply 1120. This may allow heat to be transferred to the external heat sink 1132. The optical unit 1150 may include an internal optical portion (not shown) and an external optical portion (not shown), and may be configured to evenly scatter light emitted by the light source module 1140.

The light source module 1140 may receive power from the power supply 1120 to emit light to the optical unit 1150. The light source module 1140 may include at least one light emitting device 1141, a circuit board 1142, and a controller 1143, and the controller 1143 may store driving information of the at least one light emitting device 1141. The controller 1143 may store the driving information of the at least one light emitting device 1141 every predetermined period. When brightness, a driving voltage, a driving current, and the like of the at least one light emitting device 1141 are rapidly changed, the controller 1143 may store the driving information of the at least one light emitting device 1141 regardless of whether the predetermined period has elapsed.

Next, referring to FIG. 13, a lighting device 1200 according to an example embodiment may include a reflector 1210 disposed above a light source module 1240, unlike the lighting device 1100 according to the example embodiment illustrated in FIG. 12. The reflector 1210 may reduce glare by evenly diffusing light emitted by light sources 1241 to a side surface and rear of the reflector 1210.

A communications module 1260 may be mounted on an upper portion of the reflector 1250, and may perform home network communications. For example, the communications module 1260 may be a wireless communications module using Zigbee®, Wi-Fi, or light fidelity (Li-Fi), and may control on and off functions and brightness of a lighting device installed in and around a home through a smartphone or a wireless controller. Further, use of a Li-Fi communications module using a visible light wavelength of a lighting apparatus installed in and around residential, commercial, or industrial spaces may control electronics, such as a television, a refrigerator, an air-conditioner, a door lock, or may control a vehicle.

The reflector 1250 and the communications module 1260 may be covered with the optical unit 1270.

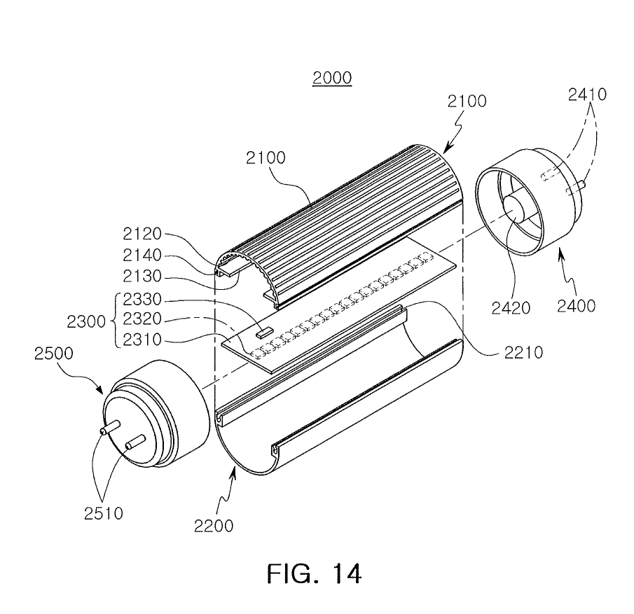

FIG. 14 is a schematic exploded perspective view of a bar-type lamp which may be applied to a lighting system according to an example embodiment.

More specifically, a lighting device 2000 may include a heat sink 2100, a cover 2200, a light source module 2300, a first socket 2400, and a second socket 2500. A plurality of heat sink fins 2110 and 2120 may have an uneven shape on internal or/and external surfaces of the heat sink 2100, and may be designed to have various shapes and intervals. The heat sink 2100 may have protruding supports 2130 formed on an inside thereof. The protruding supports 2130 may be fixed to the light source module 2300. The heat sink 2100 may have protrusions 2140 respectively formed on opposing ends thereof.

The cover 2200 may have grooves 2210 formed therein, and the protrusions 2140 of the heat sink 2100 may be coupled to the grooves 2210 by a hook coupling structure, respectively. Locations of the grooves 2210 and the protrusions 2140 may be reversed with each other.

The light source module 2300 may include a light emitting device array. The light source module 2300 may include a printed circuit board (PCB) 2310, light sources 2320, and a controller 2330. As described above, the controller 2330 may store driving information of the light sources 2320. The PCB 2310 may have circuit lines formed thereon to operate the light sources 2320. The PCB 4451 may also include components operating the light sources 2320.

The controller 2330 and the PCB 2310 may correspond to a control device of a lighting system according to an example embodiment. Meanwhile, the PCB 2310 may have a plurality of sensors provided thereon in addition to the light sources 2320 to detect internal humidity and temperature of the light source module 2300, or brightness of the light sources 2320. The controller 2330 may obtain information detected by the plurality of sensors, and driving information of the light sources 2320, and may store the obtained information every predetermined period. The controller 2330 may compare the information detected by the plurality of sensors, and the driving information of the light sources 2320 to a predetermined reference range to check whether a certain event has occurred in the lighting device 2000. When it is determined that the information detected by the plurality of sensors and the driving information of the light sources 2320 are beyond the predetermined reference range, the controller 2330 may determine that the event has occurred.

The first and second sockets 2400 and 2500 as a pair of sockets may have a structure in which the first and second sockets 2400 and 2500 are coupled to both ends of a cylindrical cover unit including the heat sink 2100 and the cover 2200, respectively. For example, the first socket 2400 may include electrode terminals 2410 and a power supply 2420, and the second socket 2500 may include dummy terminals 2510 disposed thereon. In addition, one of the first and second sockets 2400 and 2500 may have an optical sensor and/or a communications module built therein. For example, the second socket 2500 with the dummy terminals 2510 disposed thereon may have an optical sensor and/or a communications module built therein. As another example, the first socket 2400 with the electrode terminals 2410 disposed thereon may have an optical sensor and/or a communications module built therein.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

The communication units, micro controller unit, PnP manager, control devices, drivers, processors, and other processing features of the disclosed embodiments may be implemented in logic which, for example, may include hardware, software, or both. When implemented at least partially in hardware, the calculation units, control units, and other processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, communication units, control devices, drivers, micro controller unit, PnP manager, processors, and other processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

One or more embodiments may provide a lighting system, a lighting control device, and a lighting control method that monitor a space in which the lighting system is provided, and an operating state of the lighting system itself by connecting various types of sensors to the lighting system in which an LED is employed as a light source.

According to one or more example embodiments, a lighting control device may automatically recognize a sensor connected through various types of communications interfaces, may collect information obtained by the sensor, and may store the collected information every predetermined period. In addition, when an event, e.g., a change in a place in which a lighting system is installed, a failure of an LED or an LED driver, or any dramatic change in a parameter being measured, occurs, the lighting control device may store event data output by the sensors regardless of the predetermined period, thereby monitoring an operating state of the lighting system and a space or environment in which the lighting system is provided.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1. A lighting system, comprising:
a sensor unit including at least one sensor;
a lighting unit having at least one light emitting diode (LED) and a driver to drive the at least one LED; and
a control device connected to the driver and the sensor unit to communicate therewith, and to store operational information of the driver and general data output by the sensor unit every predetermined period,
wherein, if an event occurs, the control device stores operational information of the driver and event data output by the sensor unit at a time when the event occurs.

2. The lighting system as claimed in claim 1, wherein the control device comprises:
a memory to store operational information of the driver and data output by the sensor unit as information;
a processor to store the information to the memory and manage the stored information; and
a communication interface connected to the sensor.

3. The lighting system as claimed in claim 2, wherein the communication interface includes at least one of inter-integrated circuit (I²C), RS485, digital addressable lighting interface (DALI), universal asynchronous receiver/transmitter (UART), and serial peripheral interface (SPI).

4. The lighting system as claimed in claim 2, wherein the control device transmits the information stored in the memory to an external server.

5. The lighting system as claimed in claim 2, wherein the sensor unit includes a plurality of sensors and the communication interface includes a plurality of communication interfaces, the processor collects information of each of the plurality of sensors through the communications interfaces to recognize the plurality of sensors, and operates the plurality of sensors based on the collected information.

6. The lighting system as claimed in claim 2, wherein the processor comprises a configuration circuit to control operations of the driver through the communications interface.

7. The lighting system as claimed in claim 1, wherein the sensor unit includes a plurality of sensors including at least one of a global positioning system (GPS) sensor, a humidity sensor, a temperature sensor, an illumination sensor, and an ambient light sensor.

8. The lighting system as claimed in claim 1, wherein the control device determines whether the event occurs based on a comparison of at least one of operational information of the driver and data obtained by the sensor unit to predetermined values.

9. The lighting system as claimed in claim 1, wherein, when the event occurs, the control device stores operational information of the driver and event data output by the sensor unit at a time when the event occurs, regardless of the predetermined period.

10. The lighting system as claimed in claim 1, wherein the control device stores at least one of values of a voltage and a current supplied to the at least one LED by the driver as operational information of the driver.

11. A lighting control device, comprising:
a memory to store data;
a communication unit having a plurality of communications interfaces connected to a driver to drive a light emitting diode (LED) and a plurality of sensors; and
a processor to store information transmitted through the plurality of communications interfaces to the memory and manage the stored information,
wherein the processor includes a configuration circuit to control operations of the driver, and provide a plug-and-play (PnP) function recognizing a device connected to the plurality of communications interfaces.

12. The lighting control device as claimed in claim 11, wherein the processor stores information transmitted through the plurality of communications interfaces to the memory every predetermined period.

13. The lighting control device as claimed in claim 11, wherein, if a certain event occurs, the processor stores information transmitted through the plurality of communications interfaces to the memory at a time when the event occurs.

14. The lighting control device as claimed in claim 13, wherein the processor determines that the event has occurred when it is determined that at least one of peripheral information collected by the plurality of sensors and output value information of the driver is outside a predetermined reference range.

15. The lighting control device as claimed in claim 14, wherein the processor transmits that the event has occurred to an external server.

16. The lighting control device as claimed in claim 11, wherein the configuration circuit controls operations of the driver based on at least one of an operating mode of the driver, voltage and current values required to be output by the driver, and identification information of the LED driven by the driver.

17. The lighting control device as claimed in claim 11, wherein the plurality of communications interfaces includes at least one of inter-integrated circuit (I²C), RS485, digital addressable lighting interface (DALI), universal asynchronous receiver/transmitter (UART), and serial peripheral interface (SPI).

18-20. (canceled)

21. A lighting system, comprising:
a sensor;
a lighting unit including a light emitting diode (LED) and a driver to drive the LED; and
a control device connected to the driver and sensor to communicate therewith, the control device to monitor at least one of operational information of the driver and data output from the sensor to determine whether an event has occurred, and to store operational information of the driver and event data when the event has occurred as event information.

22. The lighting system as claimed in claim 21, wherein the control device transmits event information to an external server.

23. (canceled)

24. The lighting system as claimed in claim 21, wherein the control device determines whether an event occurs by comparing at least one of the operational information of the driver and data output from the sensor to a predetermined reference range.
